(19) United States
(12) Patent Application Publication
(10) Pub. No.: US 2003/0219711 A1
(43) Pub. Date: Nov. 27, 2003

(54) Process for treatment of biological tissues

(75) Inventors: Aldolfo Alberto Leirner, Sao Paulo (BR); Marina Junko Shiotsu Maizato, Sao Paulo (BR); Sergio Akinori Hayashida, Sao Paulo (BR)

Correspondence Address: STEINBERG & RASKIN, P.C., 1140 AVENUE OF THE AMERICAS, 15th FLOOR, NEW YORK, NY, 10036-5803, US

(73) Assignee: FUNDACAO ZERBINI

(21) Appl. No.: 10/441,752

(22) Filed: May 20, 2003

(30) Foreign Application Priority Data
May 21, 2002 (BR) PI0202221-4

(51) Int. Cl. A01N 1/00; A01N 1/02

(52) U.S. Cl. 435/1.1

(57) ABSTRACT

“PROCESS FOR TREATMENT OF BIOLOGICAL TISSUES”, where an additional step has been added to the conventional biological tissue treatment process—lyophilization—where the material is frozen and then the frozen liquid portion is removed through vacuum sublimation; where a complementary step of tissue reconstitution is obtained through re-hydration of the material with saline solution, thereby evaporating almost all aldehyde residual material resulting in less calcification and increased valve durability after implantation; the application of lyophilization to non-treated, in natura (fresh) bovine pericardium for storage purposes; the application of lyophilization to devices made from treated bovine pericardium; and the application of lyophilization to valve prostheses manufactured from chemically pre-treated pig heart valves.

As biomaterial specialists know, the pericardium is an extremely resistant fibrous membrane that envelops the human heart, as well as the heart of many animals.

For many years, bovine pericardium has been used in the manufacture of prosthetic cardiac valves and cardiovascular prostheses in general, like valvate or non-valvate ducts, and patches used in cardiovascular procedures.

In addition to bovine pericardium, other biological tissues are also used in the manufacture of valve prostheses, like pig valves and human valves.

To be utilized in the manufacture of cardiac valves and cardiovascular prostheses, valvate or non-valvate ducts, and patches, these biological tissues, especially bovine pericardium, are chemically processed with a treatment consisting of the following steps:

harvesting the bovine pericardium tissue at the animal abattoir;

selecting the best parts of the tissue;

pre-treating the tissue in Hanks solution or similar, to wash away any residues and soluble proteins;

molding and chemically treating the tissue in a 0.5%, 7.4 pH glutaraldehyde solution over an approximately two week period, at which time the tissue is declared “tanned”;

sterile preservation of the treated and tanned tissue in a 4% formaldehyde solution until it is needed for implant in a patient;

before use, the tissue is washed in a aqueous 0.9% NaCl solution, for maximum removal of any aldehyde residue.

After its immersion in the glutaraldehyde solution, the structure of the bovine pericardium undergoes permanent alterations. There is an inter- and intra-molecular cross binding formation that takes place between the organic free radicals and the glutaraldehyde, resulting in a significant increase in the mechanical resistance of the material, as well as a decrease in its antigenicity. In other words, the glutaraldehyde makes the bovine pericardium more resistant and less antigenic.

Cardiac valves made from these treated biological tissues, more specifically treated bovine pericardium, are used worldwide as a substitute for natural cardiac valves, producing excellent results. One of the greatest advantages is that a cardiac valve made from bovine pericardium or other biological tissues doesn't require the patient to be under anticoagulant therapy. This makes these valves the preferred ones in countries where medical facilities are scarce and the financial (social-economic) status of the patient limits their access to the required anticoagulant medication and frequent lab visits to control the patient's coagulation status. This is an advantage over mechanical valves, which is one of the alternative valve prosthesis.

Other advantages of these bovine pericardium and other biological tissue valves lie in its simple construction and low manufacturing cost when compared to the commonly used mechanical valves.

However, valves made of bovine pericardium and other biological tissue valves do have less durability then mechanical valves.

This is primarily caused by the calcification of the biological tissue due to the extended contact with the blood. It is believed that this calcification occurs because of the presence of residual aldehyde in the treated biological tissue. Even though it is thoroughly washed in an aqueous solution, a quantity of residual aldehyde remains attached to the bovine pericardium and facilitates the tissue calcification. This bovine pericardium calcification accelerates ruptures that may occur in approximately half of the manufactured valves implanted in patients over a fifteen-year implant period. This leads to the necessity for a new implantation surgery.

On the other hand, because the treated tissue requires sterile conservation in liquid formaldehyde solution until it is used, storage becomes complicated since it requires replacement of the liquid solution at least every 2 years. As well, the flasks containing the formaldehyde solution are hazardous for handling and to transport from one place to another, for example from the place of storage to the operating room.

It was with the aim of almost totally eliminating the aldehyde residuals in the bovine pericardium or other glutaraldehyde treated biological tissues, leading to decreased calcification of the tissue and increased durability of the valves manufactured with the tissue, that the current “PROCESS FOR TREATMENT OF BIOLOGICAL TISSUES” was created. This process adds an additional step to the usual conventional treatment process of biological tissues: the lyophilization of the tissue. This is a process whereby the material is frozen, and then the frozen liquid portion is removed through vacuum sublimation. Later, when the biological material is needed for use, a complementary stage of tissue reconstitution is required where the tissue is re-hydrated with a saline 0.9% solution.

Thus in this lyophilization process, nearly all remaining aldehyde residues evaporate with the water, resulting in less calcification and improved valve durability once it is implanted.

Because of the lower amounts of residual aldehydes, which evaporate almost totally during the lyophilization process, lyophilized bovine pericardium is less cytotoxic. This results in lower tissue calcification and greater durability of the material.

This lyophilization process doesn't alter the mechanical properties of the bovine pericardium significantly, nor does it alter the temperature of protein denaturation.

Furthermore, this new treatment process makes it much easier to store the material, since the bovine lyophilized pericardium can be dry stored. This is much simpler than conventional treatment where the material must be stored in a liquid formaldehyde solution.

This also makes transportation and management of this material easier.

Finally, bovine pericardium obtained through this new process can be easily sterilized. This process allows more common sterilization methods to be used, such as ethylene oxide or gamma radiation, in place of the usual sterile solution immersion.

With the new treatment process, the in natura (fresh) bovine pericardium or other biological tissue which has been treated with the glutaraldehyde solution is lyophilized and stored for later use. It doesn't require special care, and offers the following advantages: its mechanical properties are not significantly altered; it offers better biocompatibility and less calcification; and finally storage and sterilization don't require immersion in sterile solution, like formaldehydes or glutaraldehydes (which need to be replaced every 2 years).

As an option, lyophilization can also be applied on non-treated, in natura (fresh) bovine pericardium, allowing its long storage and later use as fresh pericardium.

Normally, bovine pericardium cannot be stored in its original state (fresh), and has to be submitted to treatment process immediately after harvest.

Through lyophilization, it is possible to store in natura (fresh) bovine pericardium for long periods of time, with no special care or refrigeration needs. After reconstitution, a product equivalent to fresh bovine pericardium is obtained and can be used like the fresh bovine pericardium as it were immediately after harvesting.

Yet another option of the new lyophilization treatment process is that it can be applied to devices made from treated bovine pericardium, such as valves, patches, ducts or other devices. They also will lose none of their functional characteristics and, when reconstituted, offer the following advantages: the mechanical properties are not significantly altered; there is better biocompatibility and less calcification; and storage and sterilization don't require immersion in sterile solutions like formaldehydes or glutaraldehydes (which need to be replaced every 2 years).

The final option for the new lyophilization treatment process is the application on valve prostheses manufactured from chemically pre-treated pig heart valves. This offers the same advantages: the mechanical properties are not significantly altered; there is better biocompatibility and less calcification; and storage and sterilization don't require immersion in sterile solutions like formaldehydes or glutaraldehydes (which need to be replaced every 2 years).

The current focus of this Invention patent is the “PROCESS FOR TREATMENT OF BIOLOGICAL TISSUES”, which comprises the following practical steps:

a) harvesting of the tissue (more specifically bovine pericardium) at the animal abattoir;

b) selecting the best parts of the tissue;

c) pre-treating the tissue in Hanks solution or similar, to wash away any residues and soluble proteins;

d) molding and chemically treating the tissue in a 0.5%, 7.4 pH glutaraldehyde solution over an approximately two week period, at which time the tissue is declared “tanned”;

e) sterile preserving of the treated and tanned tissue in a 4% formaldehyde solution until its subsequent stages; and, as an innovation, the additional steps:

f) lyophilization of the tissue, where the material is frozen, and then the frozen liquid portion is removed through vacuum sublimation; and

g) when the material is needed for use, tissue reconstitution is performed by re-hydrating it with a saline 0.9% solution.

As an option of the new treatment process, lyophilization can also be applied to the untreated, in natura (fresh) bovine pericardium, making long storage possible and allowing later use as a fresh pericardium.

In yet another option of the new process, lyophilization can be applied to devices made from treated bovine pericardium, such as valves, patches, ducts or other manufactured devices without losing any functional characteristics.

And finally, lyophilization can be applied to valve prostheses manufactured from chemically pre-treated pig heart valves.

1) “PROCESS FOR TREATMENT OF BIOLOGICAL TISSUES”, comprised of the following steps:
a) harvesting the bovine pericardium tissue at the animal abattoir;
b) selecting the best parts of the tissue;
c) pre-treating the tissue in Hanks solution or similar, to wash away any residues and soluble proteins;
d) molding and chemically treating the tissue in a 0.5%, 7.4 pH glutaraldehyde solution over an approximately two week period, at which time the tissue is declared “tanned”;
e) sterile preserving of the treated and tanned tissue in a 4% formaldehyde solution;
characterized by the following additional steps:
f) lyophilization of the tissue, where the material is frozen, and then the frozen liquid portion is removed through vacuum sublimation; and
g) when the material is needed for use, tissue reconstitution is performed by re-hydrating it with saline 0.9% solution.

2) “PROCESS FOR TREATMENT OF BIOLOGICAL TISSUES”, in accordance with claim 1, characterized by lyophilization can also be applied on non-treated, in natura (fresh) bovine pericardium, allowing a long storage period and later use as fresh pericardium.

3) “PROCESS FOR TREATMENT OF BIOLOGICAL TISSUES”, in accordance with claim 1, characterized by lyophilization can be applied to devices made from treated bovine pericardium, such as valves, patches, ducts or other manufactured devices without losing any functional characteristics.

4) “PROCESS FOR TREATMENT OF BIOLOGICAL TISSUES”, in accordance with claim 1, characterized by lyophilization can be applied to valve prostheses manufactured from chemically pre-treated pig heart valves.
